(19) United States
(12) Patent Application Publication
(10) Pub. No.: US 2005/0264515 A1
(43) Pub. Date: Dec. 1, 2005

(54) Liquid crystal display device

(75) Inventors: Eui Yeol Oh, Yongin-shi (KR); Gi Bin Kim, Siheung-shi (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 10/955,497

(22) Filed: Sep. 29, 2004

(30) Foreign Application Priority Data
Nov. 28, 2003 (KR) P2003-85588

(51) Int. Cl. G09G 3/36

(52) U.S. Cl. 345/102

(57) ABSTRACT

A liquid crystal display includes inverters, a cover, a liquid crystal display panel, and a backlight. The inverters mechanically couple a cover which supports a liquid crystal display panel and a backlight. Each of the inverters is spaced apart from a substantial heat generating electrode region. The inverters are configured to supply power to the backlight. One method of assembling a liquid crystal display includes positioning the inverters; disposing a reflecting sheet below the inverters; electrically coupling the inverters to a light source; mechanically coupling the inverters to the cover; and disposing a plurality of electrodes above the inverters such that the inverters and portions of the electrodes do not lie in a common vertical plane.

### PRIORITY CLAIM

This application claims the benefit of Korean Application No. P2003-85588, filed in Korea on Nov. 28, 2003. The disclosure of the application is incorporated by reference.

### BACKGROUND

1. Technical Field

The present invention relates to displays, and more particularly, to a liquid crystal display having an improved uniform luminance.

2. Related Art

Some liquid crystal display modules include a liquid crystal display panel having liquid crystal cells positioned between substrates. An illuminating unit is placed behind the liquid crystal display panel to improve clarity and brighten the display panel. Diffusion sheets are placed between the illuminating unit and the liquid crystal display to collect and concentrate light against the display.

FIG. 1 illustrates a liquid crystal display that includes a liquid crystal display assembly 500, a backlight assembly 300, and a bottom cover 350. The bottom cover is positioned below a gate circuit board 540, a data circuit board 520, a data carrier package 530, and a gate carrier package 550. A liquid crystal display panel 510 having a TFT substrate 511 is coupled to the gate circuit board 540. The liquid display panel 510 is positioned below a color filter substrate 513.

A common electrode is formed on the surface of the color filter substrate 513. When a voltage is applied to the liquid crystal display panel 510, an electric field forms between the common electrode and the pixel electrodes positioned on the thin film transistor substrate 511. When an electric field forms, the molecules within the liquid crystal display panel 510 align in the field and polarize the light passing through it.

As shown in FIG. 1, a backlight assembly 300 having a plurality of lamps 330 and 331, a reflective plate 333, a diffusion plate 320, and a diffusion sheet 310 are positioned behind the thin film substrate 511. A bottom cover 350 coupled to a top cover 600 holds the diffusion plate 320 and the diffusion sheet 310 in place.

As shown in FIG. 2, an inverter circuit supplies power to a lamp 1 that may partially illuminate a thin film transistor substrate 511. The inverter circuit includes a direct current/alternating current (DC/AC) converting part 31 and a plurality of output connectors 32a and 32b. The output connectors 32a and 32b convey current to the lamp 1. In the inverter shown in FIG. 2, the DC/AC converting part 31 include two transistors Q1 and Q2 and a transformer T1 that inductively couples the DC/AC converting part 31 to the output connectors 32a and 32b.

When Vcc1 is applied to the AC/DC converting part 31, the DC/AC converting part 31 transfers a driving voltage Vcc1 to the primary winding of the transformer T1. The DC/AC converting part 31 converts the direct current (DC) to an alternating current (AC) through alternating gate biases to Q1 and Q2. As shown, an AC high voltage from the DC/AC converting part 31 is conveyed to the lamp 1 with the low voltage output connector 32b sourcing an output voltage that corresponds to a current passing through the lamp 1 and a resistance R3. The transfer of electric energy through output connectors 32a and 32b may create substantial heat that must be absorbed and dissipated by other electrical components.

Because a single lamp is not sufficient to illuminate the thin film substrate 511 of FIG. 1, a plurality of inverting circuits are used to drive the plurality of lamps 330. As shown in FIG. 3, the bottom cover 350 that supports the liquid crystal display module and a backlight unit also supports the inverters 42 that convert DC to AC. A portion of the inverters shown as “A” in FIG. 3 overlie a high heat generating electrode region 43, and thus share a common vertical plane. Since a small clearance separates the inverters 42 and the bottom cover 350, heat generated by the inverters is not easily exchanged or dissipated. In some systems, the convection and conduction of this heat affects the performance of the electrode region 43, the lamps 330, and the inverters 42.

FIGS. 4 and 5 illustrate test results of an inverter attached to a 54 inch liquid crystal display module. FIG. 4 illustrates a back surface temperature distribution of an inverter 42 and FIG. 5 illustrates a lamp array temperature distribution. As shown, the overlapping regions have significant temperature increases that may create areas of intense heat or hot spots. These increases in temperature are caused in part by circuit overlap and can result in substantial temperature differences from the left to the right sides of the lamps 330 and 331 and the liquid crystal display module. The present inventions are directed to an improved display that overcomes some of these drawbacks of the related art.

### SUMMARY

A liquid crystal display includes inverters, a bottom cover, a liquid crystal display panel, and a backlight assembly. The inverters mechanically couple a bottom cover which supports a liquid crystal display panel and a backlight. Each of the inverters is spaced apart from the substantial heat generating electrode regions. The inverters are configured to supply power to the backlight.

A method of assembling a display includes spacing the inverters apart from the electrodes. An alternative method of assembling a display includes positioning the inverters; disposing a reflecting sheet below the inverters; electrically coupling the inverters to a light source; mechanically coupling the inverters to a bottom cover; disposing a plurality of electrodes above the inverters such that the inverters and the portion of the electrodes that generate most of the electrode's heat do not lie in a common vertical plane.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The inventions can be better understood with reference to the following drawings and description. The components in the figures are not necessarily to scale, emphasis instead being placed upon illustrating the principles of the inventions. Moreover, in the figures, like referenced numerals designate corresponding parts throughout the different views.

FIG. 1 illustrates an exploded perspective view of a liquid crystal display device;

FIG. 2 illustrates a schematic of an inverter circuit of FIG. 1;

FIG. 3 illustrates a plan view of a bottom cover supporting a plurality of inverter circuits of FIG. 2;

FIG. 4 illustrates a back surface temperature distribution of the inverters of FIG. 3;

FIG. 5 illustrate a lamp array temperature distribution;

FIG. 6 illustrates a plan view of a bottom cover supporting a plurality of inverters;

FIG. 7 illustrates a simulated back surface temperature distribution of the inverters of FIG. 6;

FIG. 8 illustrates a simulated temperature distribution of the lamps;

FIG. 9 is a flow diagram of an assembly of a liquid crystal display embodiment; and

FIG. 10 is an alternative flow diagram of an assembly of a liquid crystal display embodiment.

### DETAILED DESCRIPTION OF THE EMBODIMENTS

The layout of a crystal display device may improve the operation and visual output of the display. The system and the method of assembly dissipate heat to prevent areas of intense heat that may cause overheating. By minimizing overlap between high heat generating regions, significant temperature differences may not occur across the lamps that form the lamp arrays, which may improve the uniform luminescence and the picture quality of the liquid crystal display.

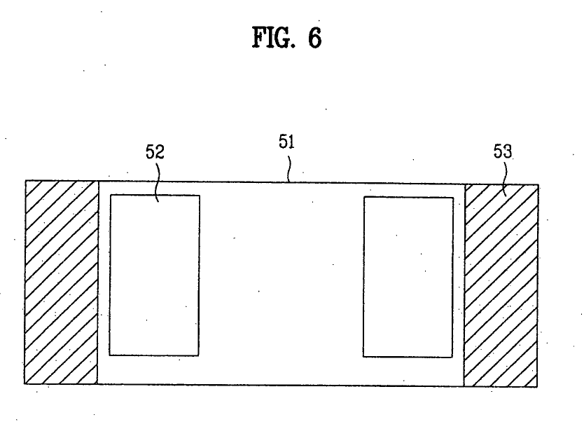

FIG. 6 illustrates a plan view of part of a liquid crystal display embodiment. The liquid crystal display embodiment includes inverters 52 coupled to an underside surface of an electroluminescent panel. A bottom cover 51 accommodates and/or supports a liquid crystal display panel assembly and a backlight assembly. The backlight assembly includes one or more inverters 52 (two of which are shown) spaced apart from a portion of an electrode region that generates most of the electrode's heat. Vertical planes divide the inverters 52 from the high heat generating electrode regions 53 such that each inverter and each high heat generating electrode region lie in separate vertical planes. A plane of symmetry (not shown) also divides the high heat generating electrode regions 53 and inverters 52 to maximize heat dissipation. In alternative embodiments, the inverters 53 are spaced apart in many other configurations.

In the above described embodiments, heat is exchanged from the inverters 52 and the high heat generating portions 53 of the electrode through conduction, convection, and/or radiation. Conduction transfers heat within the inverter 52. If the temperature of one portion of the inverter 52 is raised, the heat travels to the cooler portion of the inverter 52. Conduction also may occur when the inverters 52 are brought into contact with another object. Conduction between a solid surface and a moving gas or liquid called convection may occur in alternative embodiments. The motion of the fluid or gas may flow by a natural or artificial force. Radiation is different from both conduction and convection because the objects exchanging heat need not be touching and may be separated by a vacuum.

To assemble an embodiment of a liquid crystal display, the inverters 52 are mechanically coupled to a back surface of a bottom cover 51 at act 902. The term couple or coupled, in all uses, herein, is intended to encompass both direct and indirect coupling. Thus, an inverter 52 and a bottom cover 51 are said to be coupled together when they are in direct contact, as well as when the inverter 52 couples an intermediate part, which couples the bottom cover 51 directly or via one or more additional parts.

The bottom cover 51 is positioned below a reflecting sheet. The reflecting sheet reflects light from an electroluminescent display or a plurality of lamps that are disposed below a medium that scatters light almost evenly at act 904. The reflecting sheet may increase the amount of light that is incident to the liquid crystal display panel while minimizing the light lost through the bottom cover 51. A medium that scatters light almost evenly may comprise a diffuser that may include a diffusion plate and/or a diffusion sheet.

During assembly, the first and second printed circuit boards that form part of the liquid crystal display panel are positioned above electroluminescent display at act 908. The first data circuit board and the second gate circuit board are disposed below a color filter at act 906. At act 908, the top cover partially encloses a color filter that mechanically couples a common electrode. The top cover also partially encloses the liquid crystal display panel and couples the bottom cover 51. When fully assembled, those portions of the pixel electrodes that generate most of the electrode's heat do not overlie the inverters 52. Instead the portions are exposed to air or alternatively to a sink that may absorb and dissipate heat. The sink may be made of metal or other materials and may have fins that assist in the transfer of heat.

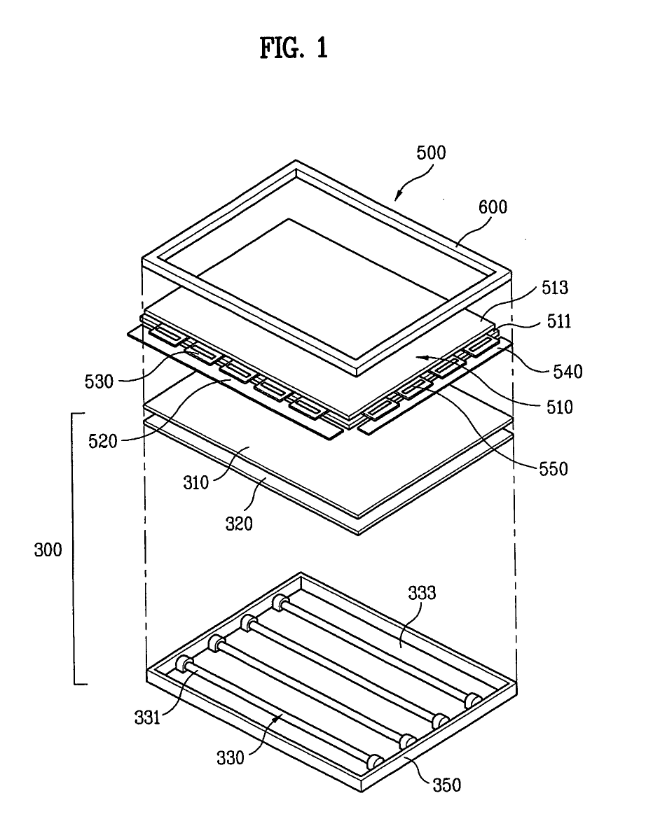

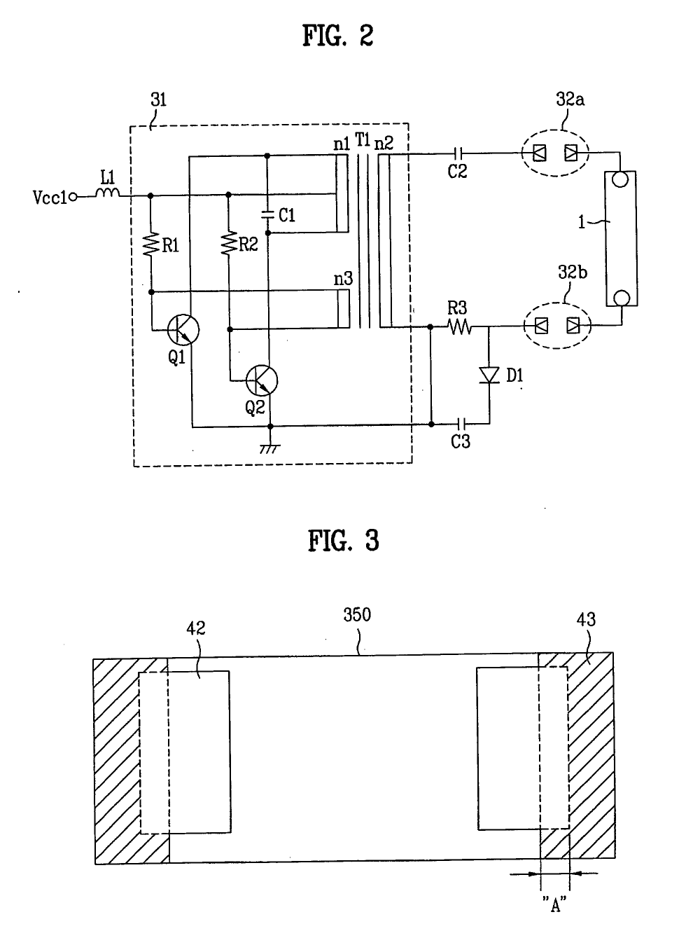

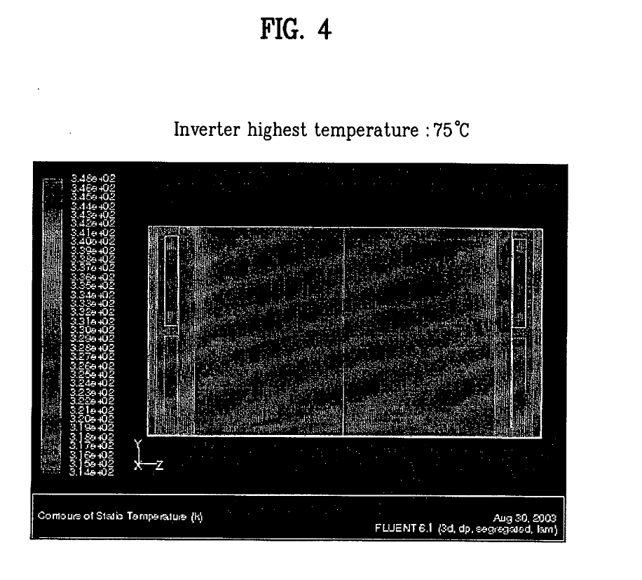

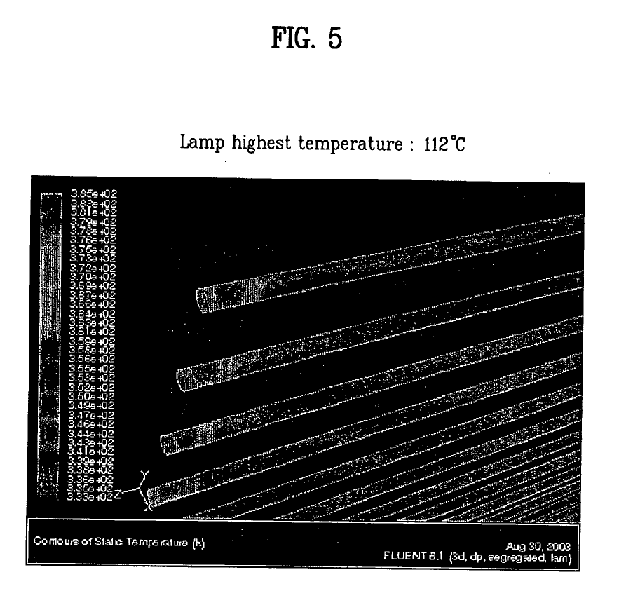

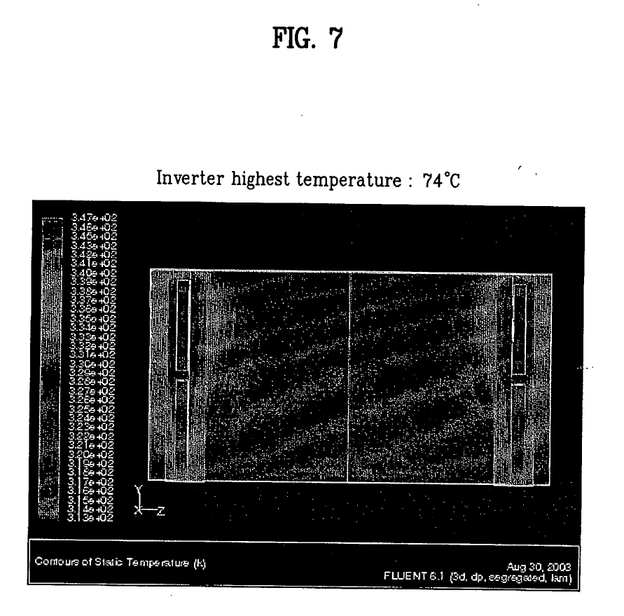

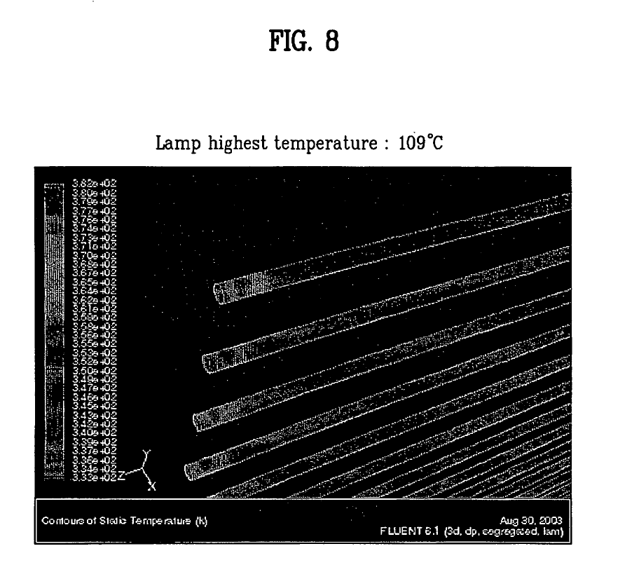

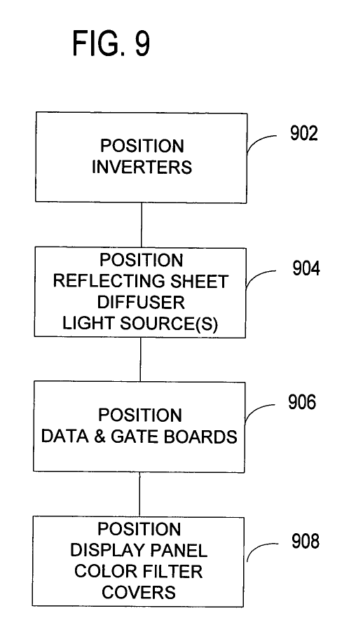

FIGS. 7 and 8 illustrate simulated measurements of an exemplary liquid crystal display. Like the embodiments shown in FIG. 6, the inverters are spaced apart from the high heat generating portions of the pixel electrodes such that these components lie in separate and/or exclusive vertical planes. In one exemplary layout, the inverters operate at a temperature that is 1° C. lower than the inverters shown in FIG. 3. A 3° C. temperature drop was also measured at an exemplary lamp array in comparison to the operating temperature of lamp array shown in FIG. 1.

The inventions are not limited to a particular light source. Any light source may be used including an EL (Electro Luminescence), LED (Light Emitting Diode), CCFL (Cold Cathode Fluorescent Lamp), and HCFL (Hot Cathode Fluorescent Lamp) in a direct or edge type configuration, for example. To achieve a preferred result in some embodiments, the heat distribution of a length of a lamp should be measured or known. In one CCFL embodiment, it was found that the portions of the heat generating components should be separated by about 40 mm.

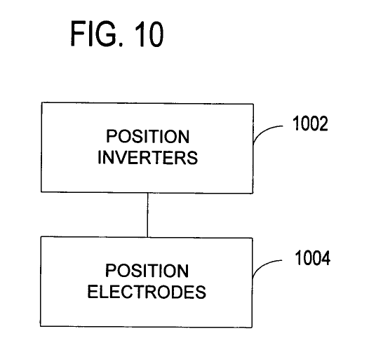

Many other alternative methods of assembly are also possible. In the alternative embodiment shown in FIG. 10, one or more inverters 52 are positioned on a surface, such as a back surface of a bottom cover at act 1002. The term “position” or “positioned” is intended to encompass a range of positions. At act 1004, one or more electrodes 53 are spaced apart from the one or more inverters 52. In some alternative embodiments, only the electrode regions generating heat or those regions that generate substantial heat when compared to other electrode regions are spaced apart from the one or more inverters 52. In the above described processes, vertical planes may divide the inverters 52 from the heat generating electrode regions 53 such that each inverter and each heat generating electrode region lie in a separate and/or exclusive vertical plane. A plane of symmetry also may divide the heat generating electrode regions 53 from the inverters 52 to maximize heat dissipation.

The liquid crystal display device improves the operation and visual output of the display. The system and the method of assembly dissipate heat and prevent overheating. The embodiments may include a light assembly that has one or more inverters 52 spaced apart from a high heat generating electrode region. Vertical planes divide the inverters 52 from the high heat generating electrode regions 53 such that each inverter and each high heat generating electrode do not lie in a common vertical area. The layout may prevent overheating by distributing heat across a larger area that may absorb and dissipate heat produced by the inverters 52, the electrode regions, the light sources, and other electrical components. By eliminating the overlying areas that generate substantially most of the display's heat, the conduction of heat across a light source becomes more uniform, which improves the uniform luminescence and picture quality of the liquid crystal display.

While various embodiments of the invention have been described above, it will be apparent to those of ordinary skill in the art that many more embodiments and implementations are possible and within the scope of the invention. Accordingly, the invention is not to be restricted except in light of the claims and their equivalents.

1. A liquid crystal display comprising:
a plurality of inverters coupled to a bottom cover which supports a liquid crystal display panel and a backlight;
wherein the inverters are spaced apart from an electrode region generating heat and the inverters are configured to supply power to the backlight.

2. The liquid crystal display of claim 1 wherein the electrode region comprises a plurality of electrodes.

3. The liquid crystal display of claim 1 wherein a plurality of vertical planes divide the inverters from the heat generating electrode regions and each inverter and heat generating electrode region reside in separate vertical planes.

4. The liquid crystal display of claim 1 wherein a plane of symmetry separates a first inverter and a first electrode region from a second inverter and a second electrode region.

5. The liquid crystal display of claim 4 wherein the first inverter, the second inverter, the first electrode, and the second electrode are configured to dissipate heat through conduction.

6. The liquid crystal display of claim 4 wherein the first inverter, the second inverter, the first electrode, and the second electrode are configured to dissipate heat through convection.

7. The liquid crystal display of claim 4 wherein the first inverter, the second inverter, the first electrode, and the second electrode are configured to dissipate heat through radiation.

8. The liquid crystal display of claim 1 wherein the inverters convert a direct current to an alternating current.

9. A liquid crystal display comprising:
a liquid crystal display panel;
a medium disposed below the liquid crystal display to spread light;
an electroluminescent member disposed below the medium;
a plurality of inverters disposed in a first vertical plane and a second vertical plane; and
a plurality of electrode regions generating heat disposed in a third vertical plane and a fourth vertical plane;
wherein the first vertical plane, second vertical plane, third vertical plane, and fourth vertical plane comprise separate vertical planes.

10. The liquid crystal display of claim 9 wherein the electrode regions comprises a plurality of electrodes.

11. The liquid crystal display of claim 9 wherein the medium comprises an optical member.

12. The liquid crystal display of claim 11 wherein the optical member comprises a diffusion plate and a diffusion sheet.

13. The liquid crystal display of claim 9 wherein a plane of symmetry separates the first and the third vertical planes from a second and the fourth vertical planes.

14. The liquid crystal display of claim 9 wherein the inverters and the electrodes are configured to dissipate heat through radiation.

15. The liquid crystal display of claim 9 wherein the inverters and the electrodes are configured to dissipate heat through conduction.

16. The liquid crystal display of claim 9 wherein the inverters and the electrodes are configured to dissipate heat through convection.

17. The liquid crystal display of claim 9 wherein the first vertical plane, the second vertical plane, the third vertical plane, and the fourth vertical plane comprise exclusive vertical planes.

18. A liquid crystal display comprising:
a liquid crystal display panel;
a medium disposed below the liquid crystal display panel that spreads light;
a light source disposed below the medium;
means for converting electrical signals from one form to another form disposed in a vertical plane; and
a heat generating electrode region disposed in a separate vertical plane;
wherein the plane that contain the means for converting electrical signals lies in an exclusive vertical plane from the vertical plane that contains the heat generating electrode region.

19. The liquid crystal display of claim 18 wherein the means for converting electrical signals comprises a plurality of means for converting electrical signals.

20. The liquid crystal display of claim 18 wherein the means for converting electrical signals is mechanically coupled to a back cover and electrically coupled to a light source.

21. A method of assembly a display comprising:
positioning a plurality of inverters in a plurality of vertical planes; and
positioning a plurality of electrodes in separate vertical planes from the vertical planes containing one or more of the plurality of inverters.

22. The method of assembling a display of claim 21 wherein the act of positioning the plurality of inverters comprises positioning the inverters on opposite sides of a surface that is divided by a plane of symmetry.

23. The method of assembling a display of claim 22 wherein the inverters are electrically coupled to a plurality of light sources.
